(19) United States
(12) Patent Application Publication
(10) Pub. No.: US 2026/0340336 A1
(43) Pub. Date: Oct. 29, 2026

(54) ON-DEMAND TRAINING AND DEPLOYMENT OF BOTS

(71) Applicant: NTT DATA Americas, Inc., Plano, TX (US)

(72) Inventors: Ujjwal Sharma, Chennai (IN); Dhurai Ganesan, Chennai (IN); Aananthanarayanan Pandian, Chennai (IN); Gowrishanker Pari, Chennai (IN); Rohit Puri, Plano, TX (US)

(21) Appl. No.: 19/189,071

(22) Filed: Apr. 24, 2025

(51) Int. Cl. G06N 3/006

(52) U.S. Cl. CPC G06N 3/006

(57) ABSTRACT

In an embodiment, a method for on-demand training and deployment of bots includes receiving a command to initiate on-demand robotic execution in relation to at least one skillset. The method also includes allocating a bot for the at least one skillset responsive to the command. The method also includes automatically provisioning a workspace for the bot based on the at least one skillset. The method also includes automatically training the bot for the at least one skillset using stored content related to human training for the at least one skill set. The method also includes commanding the automatically trained bot to execute one or more tasks related to the skillset.

### INTRODUCTION

Task automation, while often desirable, is not always feasible. Robotic process automation (RPA) platforms have a tendency to provide a framework for automating tasks without providing a streamlined way to determine what should be automated and ensure its timeliness and effectiveness in practice.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, in an embodiment, a method for on-demand training and deployment of bots includes receiving a command to initiate on-demand robotic execution in relation to at least one skillset. The method also includes allocating a bot for the at least one skillset responsive to the command. The method also includes automatically provisioning a workspace for the bot based on the at least one skillset. The method also includes automatically training the bot for the at least one skillset using stored content related to human training for the at least one skill set. The method also includes commanding the automatically trained bot to execute one or more tasks related to the skillset.

In another general aspect, in an embodiment, a system includes a processor and memory, where the processor and memory in combination are operable to implement a method for on-demand training and deployment of bots. The method includes receiving a command to initiate on-demand robotic execution in relation to at least one skillset. The method also includes allocating a bot for the at least one skillset responsive to the command. The method also includes automatically provisioning a workspace for the bot based on the at least one skillset. The method also includes automatically training the bot for the at least one skillset using stored content related to human training for the at least one skill set. The method also includes commanding the automatically trained bot to execute one or more tasks related to the skillset.

In another general aspect, in an embodiment, a computer-program product includes a non-transitory computer-usable medium having computer-readable program code embodied therein, the computer-readable program code adapted to be executed to implement a method for on-demand training and deployment of bots. The method includes receiving a command to initiate on-demand robotic execution in relation to at least one skillset. The method also includes allocating a bot for the at least one skillset responsive to the command. The method also includes automatically provisioning a workspace for the bot based on the at least one skillset. The method also includes automatically training the bot for the at least one skillset using stored content related to human training for the at least one skill set. The method also includes commanding the automatically trained bot to execute one or more tasks related to the skillset.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example of a system for implementing a central management system.

FIG. 2 illustrates an example of an environment for an on-demand training and deployment system.

FIG. 3 illustrates an example of a process for operating an on-demand training and deployment system.

FIG. 4 illustrates an example of a process for cloning a trained bot in response to a resource demand.

FIG. 5 illustrates an example of a process for updating bots based on feedback.

FIG. 6 illustrates an example of a computer system.

### DETAILED DESCRIPTION

Robotic process automation (RPA) is the use of software, typically in combination with artificial intelligence (AI) and machine learning (ML) capabilities, to handle high-volume sequences of repeatable tasks that previously required humans to perform. These tasks can include interacting with a user interface (UI), for example, to perform queries, calculations, maintenance of records and transactions, web automations, remote operations, database functions, terminal connections, desktop operations, text operations, mouse simulations, keyboard simulations, folder operations, file handlers, clipboard handlers, combinations of the foregoing and/or the like. RPA technology can mimic a human worker, for example, by logging into applications, entering data, calculating and completing tasks, and logging out.

RPA technology is not always part of an organization's information technology (IT) infrastructure, but can instead, sit on top of it, enabling an organization to implement RPA technology quickly and efficiently, without changing the existing infrastructure and systems. In various embodiments, a computing environment can include, for example, many hundreds or thousands of software agents, often referred to herein as “bots,” that automatically perform robotic processes. In various cases, the sequence of computer-implemented tasks performed by each bot can be the same or different, or a combination thereof. Oftentimes, the computing environment can further include, for example, many hundreds or thousands of human workers that likewise execute the same or similar computer-implemented tasks, or a combination thereof, via manual interaction with UIs. A set or sequence of computer-implemented tasks, such as the foregoing example tasks, may be referred to as a user-executed process.

Although bots, potentially in combination with human workers, can provide greater efficiency via increased automation, bots introduce numerous technical problems. For example, even when RPA is implemented for performing some business process, many processes continue to be performed manually. Even when automation takes over business processes, it is uncertain that the technology being used for the automation projects are efficient enough to perform those projects.

In today's competitive world of digital technology, it is more important than ever to utilize more efficient, and hence often complicated, automation systems. Many businesses nowadays adopt to automate internal business operations in order to reduce operating expenses and boost productivity. Automating business processes in the organization may be extremely advantageous, possibly allowing organization to reduce the cost of automated job activities while double their productivity. However, a botched automation project can result in resources being squandered and may prevent businesses from pursuing further automation initiatives for an extended period of time, eventually placing them behind rivals who embrace automation and make it work.

Identifying the right automation opportunity is technically difficult. An automation project's failure is sometimes ascribed to a poor use-case selection, as well as the technological solutions chosen for the initial trial or proof of concept (PoC). Furthermore, the complexity of today's digital world makes manual analysis and processing impractical. Using manual procedures are generally inefficient and results in sluggish and error-prone results.

In various embodiments, on-demand training and deployment of bots as described herein can overcome obstacles such as those described above. The present disclosure describes examples of an automated system that can automatically train bots for skillsets using stored content, for example, related to human training for the skillsets. Examples will be described below relative to the Drawings.

For purposes of this application, the term “UI” can include, without limitation, any type of human-machine interface. Example UIs include text-based interfaces such as command-line interfaces, conversational interfaces, crossing-based interfaces, direct manipulation interfaces, gesture interfaces, graphical UIs (GUIs), hardware interfaces, holographic UIs, intelligent UIs, motion tracking interfaces, natural-language interfaces, object-oriented UIs, reflexive UIs, touchscreen interfaces, touch UIs, voice UIs, and web-based UIs. Many of the aforementioned UIs accept input via input devices such as a keyboard, mouse, microphone, combinations of the foregoing, and/or the like. Inputs from any of these devices, in possible combination with specific UI objects or components, can be considered examples of UI events. For illustrative purposes, various examples will be described herein relative to GUIs and UI events that are detected or received in relation to GUIs. It should be appreciated, however, that the principles described herein are applicable to any type of UI, inclusive of the example UIs mentioned previously. A user, unless specifically stated otherwise, or otherwise understood within the context as used, can include any entity, including a human or bot, that can interact with a UI.

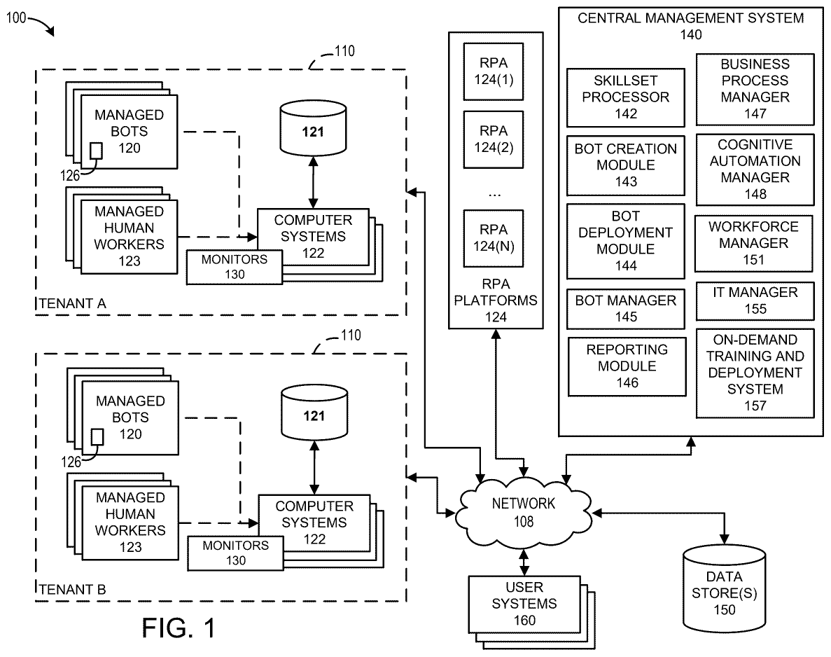

FIG. 1 illustrates an example of a system 100 for implementing a central management system 140 for user-executed processes. The system 100 includes the central management system 140, tenant systems 110, RPA platforms 124, user systems 160 and one or more data stores 150, each of which is operable to communicate over a network 108. The network 108 may be, or include, one or more of a private network, a public network, a local or wide area network, a portion of the Internet, combinations of the same, and/or the like.

In some aspects, the central management system 140 can centrally manage bot deployments on the RPA platforms 124 for its tenants. The RPA platforms 124 are shown to include an RPA platform 124(1), an RPA platform 124(2) and an RPA platform 124(N). It should be appreciated that three RPA platforms are shown among the RPA platforms 124 only for illustrative purposes. In various implementations, any number of RPA platforms can be included among the RPA platforms 124. In a typical embodiment, the RPA platforms 124 each provide RPA software for creating and executing bots, generally using different RPA technology, interfaces and formats.

In particular, in the system 100, the tenant systems 110 can be served by the central management system 140. In general, the tenant systems 110 can each be considered an abstraction of users, inclusive of both bots and human workers, that execute user-executed processes managed by the central management system 140, and the systems and data sources with which those users interact. For example, one of the tenant systems 110 is shown as owned or operated by “Tenant A” while another system 110 is owned or operated by a different tenant, “Tenant B.” The tenant systems 110 shown can be owned or operated by the same or different entities. For example, Tenants A and B can represent customers (e.g., entities such as companies or individuals) of an operator of the central management system 140. Although the term “tenant” is used herein to describe the tenant systems 110 or owners/operators thereof, in addition to having its ordinary meaning, the term “tenant” can, but need not, refer to tenancy in a multitenant software architecture.

The tenant systems 110 are each shown to include one or more managed bots 120, one or more managed human workers 123, one or more computer systems 122, and one or more data sources 121. The one or more computer systems 122 can each provide a computing environment, inclusive of applications and corresponding UIs and dashboards, for executing configurable tasks. As illustrated, any given one of the computer systems 122 may be operated by one of the managed bots 120 or one of the human workers 123. In some cases, the computer systems 122 may represent desktop virtualization environments. In such cases, the human workers 123, for example, may operate the user systems 160 and access the desktop virtualization environments over the network 108.

The one or more data sources 121 of each of the tenant systems 110 can include data streams or datasets that can be received or processed by the computer systems 122, potentially as part of executing the configurable tasks. In various cases, the one or more data sources 121 can be updated by the computer systems 122, or other components, in real-time, on a periodic basis, e.g., according to a schedule, on-demand or a combination of the same. In various cases, the tasks for which the computer systems 122 are configured can be executed in the respective computing environments, for example, manually by the human workers 123 and/or robotically by the managed bots 120. In a typical embodiment, the managed bots 120 are each deployed on an RPA platform of the RPA platforms 124 and interact as users in the computing environments of the computer systems 122 for purposes executing some or all of the configurable tasks as robotic processes.

The managed bots 120 can each include an instruction set 126 that can be used to provide the managed bots 120 a complete set of all computer-implemented tasks or steps that are to be performed in sequence automatically by the managed bots 120, for example, as a user-executed process. In some embodiments, the instruction set 126 is in a machine-readable code that can be recognized and executed by a central processing unit. In various embodiments, the instruction set 126 can be made up of, for example, a markup language, a low-level programming language, a high-level programming language, a scripting language, a machine language, an assembly language or any combination thereof.

As illustrated, the computer systems 122 can include skillset monitors 130. The skillset monitors 130 are software agents that can be used to facilitate automated creation of some or all of the managed bots 120. In certain embodiments, the skillset monitors 130 can be individually triggered, for example, by a human user of one of the user systems 160, to monitor and record user activity in the computing environments provided by the computer systems 122. The user activity can represent, for example, user-executed processes in the computing environments. The user activity can include, for example, UI activity.

In the illustrated embodiment, the central management system 140 can include a skillset processor 142, a bot creation module 143, a bot deployment module 144, a bot manager 145, a reporting module 146, a business process manager 147, a cognitive automation manager 148, a workforce manager 151, an IT manager 155, and an on-demand training and deployment system 157. Each of these components can be implemented with hardware and/or software, including (optionally) virtual machines and containers. In an example, the central management system 140 can be implemented as a single management server. In another example, the central management system 140 can be implemented in a plurality of virtual or physical servers, which may or may not be geographically co-located. In some embodiments, the central management system 140 and/or other aspects of the system 100 may be hosted on a cloud-provider system.

In certain embodiments, features of the components of the central management system 140 can be made accessible over an interface to the user systems 160. The user systems 160 can include any type of computing device, including desktops, laptops, tablets, and smartphones, to name a few. The user systems 160 can be operated by users, such as the human workers 123, or by other users, for example, for administration purposes.

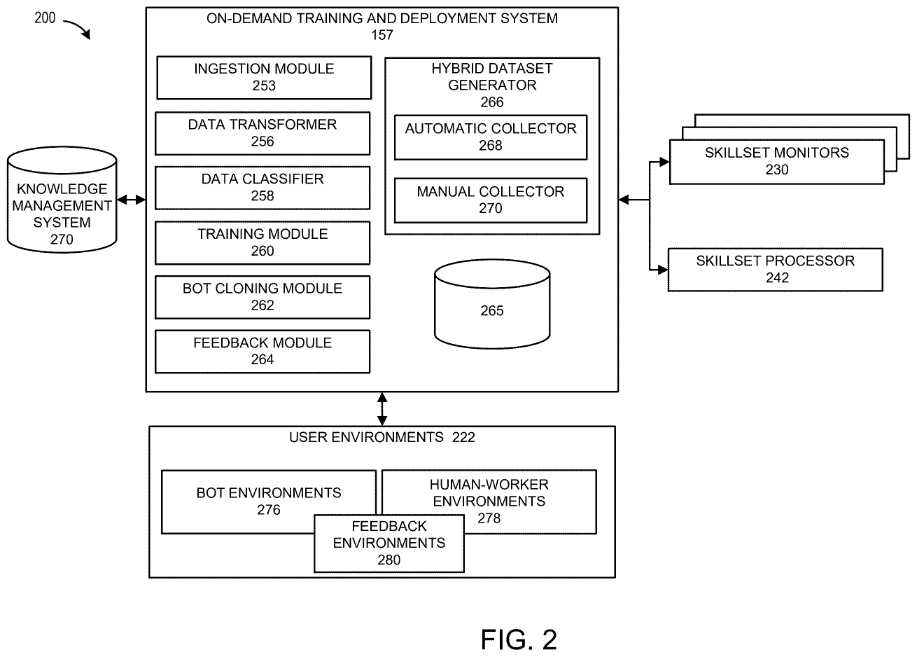

The skillset processor 142 can, for each of the tenant systems 110, in collaboration with the skillset monitors 130, monitor execution of user-executed processes by the managed bots 120 and/or the human workers 123. Operation of the skillset processor 142 and the skillset monitors 130 will be described in greater detail relative to FIG. 2.

The bot creation module 143 can be utilized to create bots such as, for example, the managed bots 120. In some embodiments, an instruction set is created via the bot creation module 143 that contains all of the instructions and/or modules for a specific type of bot. The instruction set that is created can be similar to the instruction set 126 of each of the managed bots 120. In certain embodiments, the bot creation module 143 can utilize information from the skillset processor 142 and/or the on-demand training and deployment system 157, for example, to automatically create each instruction set. In some embodiments, the bot creation module 143 includes or provides a configuration interface for manual creation of an instruction set, or for revision or tuning of an automatically created instruction set. The configuration interface can be accessible, for example, by the user systems 160.

In certain embodiments, the bot deployment module 144 can be utilized to deploy a bot on the RPA platforms 124 for a tenant, such that the deployed bot becomes one of the managed bots 120. In various embodiments, the bot deployment module 144 can utilize an instruction set created by the bot creation module 143 that can then be deployed. For example, the instruction set 126 of one of the managed bots 120 could be representative of a bot created by the bot creation module 143 and then deployed via the bot deployment module 144. In certain embodiments, the bot deployment module 144 can be used to deploy a single bot and/or a plurality of bots concurrently. In many cases, the bot deployment module 144 can be utilized to deploy bots on a variety of the RPA platforms 124. In some embodiments, the bot deployment module 144 can publish a configuration interface to the user systems 160, for example, for administrators, super users or other users (e.g., of a particular tenant) to select or specify such commands. In other embodiments, the bot deployment module 144 executes an automatic process to deploys bots without manual interaction. In various embodiments, the bot deployment module 144 can store command sets for some or all of the RPA platforms 124.

The bot manager 145 can serve to manage bots such as, for example, the managed bots 120, for tenants. In certain embodiments, the bot manager 145 can issue commands to control operation of bots. The bot manager 145 can be utilized to re-configure, optimize and/or customize any of the managed bots 120. For example, various commands can start or stop bots, perform configuration management, combinations of the same and/or the like. In some cases, the bot manager 145 can publish a configuration interface to the user systems 160, for example, for administrators, super users or other users (e.g., of a particular tenant) to select or specify such commands.

The reporting module 146 can generate regular or on-demand reports related to the managed bots 120 and the managed human workers 123. In various cases, these reports can provide a snapshot of some or all of the managed bots 120 and the managed human workers 123 (e.g., regarding performance gaps as described further below). The reporting module 146 can publish reports or other generated information, for example, to a webpage, user dashboard, and/or the like. The reporting module 146 can generate and execute a query of the one or more data stores 150, as appropriate. The web page, user dashboard or other UI(s) output, for example, by the reporting module 146, can be accessed by certain users of the user systems 160.

The business process manager 147 includes tools and interfaces to manage business processes in the system 100, inclusive of user-executed processes. For example, the business process manager 147 can maintain, for the tenant systems 110, business process specifications as a series of tasks, dependencies between business processes, combinations of the foregoing and/or the like.

The cognitive automation manager 148 can orchestrate cognitive automation in the system 100, for example, as may be implemented by the managed bots 120. In various embodiments, the cognitive automation manager 148 can manage, track, and/or implement some or all instances of intelligent process automation that are used by or with respect to the tenant systems 110. In certain embodiments, the cognitive automation manager 148, in combination with other elements of the system 100, utilizes continuous learning, automatic recommendations, and automatic scoring and decision-making features to optimize ML technologies for process automation.

The workforce manager 151 can include one or more workforce management systems that are used to manage, control, and track, for example, for each of the tenant systems 110, tasks assigned to and performed by the managed human workers 123 and/or the managed bots 120. The IT manager 155 can include software and interfaces for managing, controlling, and tracking, for example, the computer systems 122.

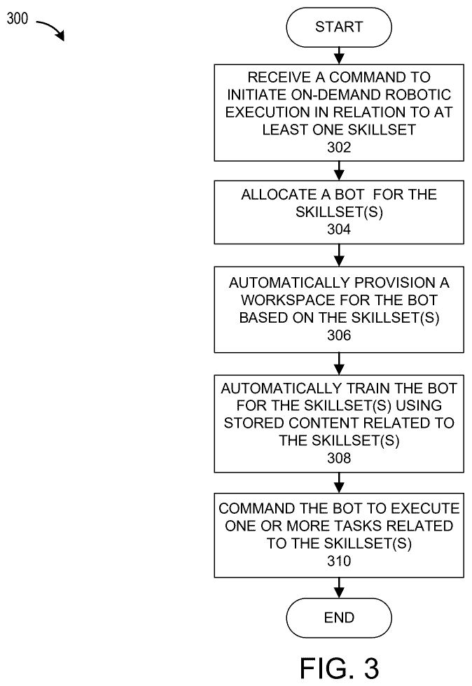

The on-demand training and deployment system 157 can, for each of the tenant systems 110, in collaboration with the skillset monitors 130, monitor execution of user-executed processes by the managed bots 120 and/or the human workers 123. In various embodiments, the on-demand training and deployment system 157 integrates data from numerous data sources, such as various components of the tenant systems 110 and/or the central management system 140, to facilitate automation of user-executed processes. Operation of the on-demand training and deployment system 157 will be described in greater detail relative to FIGS. 3-5.

In general, the one or more data stores 150 can include any information collected, stored or used by the central management system 140. For example, in various embodiments, the one or more data stores 150 can include instruction sets for bots, command sets for one or more of the RPA platforms 124, deployment settings for bots (e.g., on a tenant-specific and/or bot-specific basis), metadata for bots to be deployed, data collected from the managed bots 120, the human workers 123, or the computer systems 122, combinations of the same and/or the like. In certain embodiments, data stored in the one or more data stores 150 can take the form of repositories, flat files, databases, etc. In certain embodiments, the one or more data stores 150 can be utilized as an event library, in which actions performed by any of the managed bots 120 and/or the user systems 160 are stored. The event library can also contain business rule libraries, exception libraries, control libraries, keyboard libraries, database libraries and/or cognitive libraries.

FIG. 2 illustrates an example of an environment 200 for the on-demand training and deployment system 157 of FIG. 1. Although the environment 200 is described relative to a single user-executed process for illustrative purposes, it should be appreciated that the system 100 of FIG. 1, for example, can support a plurality of such environments for a plurality of user-executed processes. The environment 200 includes the on-demand training and deployment system 157, a knowledge management system 270, skillset monitors 230, a skillset processor 242 and user environments 222.

The user environments 222 can correspond to user environments provided, for example, by the computer systems 122 of FIG. 1. As illustrated, the user environments 222 include bot environments 276, human-worker environments 278, and feedback environments 280. The bot environments 276 are generally operated by bots such as the managed bots 120 of FIG. 1. The human-worker environments 278 are generally operated by human workers such as the managed human workers 123 of FIG. 1.

In some aspects, the feedback environments 280 can be a subset of the user environments 222 that serve, for example, as a basis for incremental learning. For example, in some aspects, the feedback environments 280 can include, for example, a subset of the human-worker environments 278 corresponding to specific human workers who have been designated as users designated or able to provide feedback on bot results or actions, for example, due to their human expertise. However, generally speaking, the feedback environments 280 can include some or all of the human-worker environments 278 and/or environments that are distinct from the human-worker environments 278.

The on-demand training and deployment system 157 is configured to execute on-demand training and deployment of bots, such as the managed bots 120 of FIG. 1, for execution of a skillset for a user-executed process. The on-demand training and deployment system 157 includes an ingestion module 253, a data transformer 256, a data classifier 258, a training module 260, a bot cloning module 262, a feedback module 264, and a hybrid dataset generator 266. As illustrated, in various embodiments, the on-demand training and deployment system 157 can communicate with the skillset monitors 130 and the skillset processor 142 in any suitable fashion. In general, the skillset monitors 230 and the skillset processor 242 can each operate as described relative to the skillset monitors 130 and the skillset processor 142, respectively, of FIG. 1. The skillset monitors 230, for example, can execute in some or all of the user environments 222.

The knowledge management system 270 can include data related to how one or more user-executed processes are executed. In various aspects, the data of the knowledge management system 270 can describe, for example, software skills and/or business process skills. In addition, or alternatively, the data of the knowledge management system 270 can describe, for example, an organizational structure, history, mission, and/or vision. In addition, or alternatively, the data of the knowledge management system 270 can describe or include, for example, ethical policies, compliance and regulations training, mandatory trainings, and/or the like.

In various examples, the knowledge management system 270 can include, for example, process documents, knowledge base files, emails, instant messages, voicemails, system alerts, on-screen tips, bite-sized training materials and/or help files in video, audio, image and/or document formats. The data of the knowledge management system 270 can be received or retrieved from other users (e.g., bots and/or human workers) and/or from systems used for training, for example, new human workers. Document formats can include, for example, one or more of Portable Document Format (PDF), Microsoft (MS) Office formats including MS Word, MS PowerPoint (PPT) and MS Excel and/or the like. The documents can further include, for example, emails or other messages in any suitable format. In addition, or alternatively, video, audio, and/or images can conform to any suitable file format or standard. The knowledge management system 270 can be stored, for example, in the one or more data stores 150 of FIG. 1.

The ingestion module 253 is operable to collect, or ingest, data of the knowledge management system 270. In various embodiments, the data can be indexed and stored, for example, in a data store 265, which can be part of the one or more data stores 150 of FIG. 1. As will be described in greater detail below, the collected or ingested data from the knowledge management system 270 can be used, in part, to execute training of bots for skills to execute one or more user-executed processes.

The data transformer 256 can transform data obtained or collected by the ingestion module 253, for example, using rules and/or machine learning techniques. In certain embodiments, the ingestion module 253 collects various data of the type above, which data may be referred to generically as heterogeneous training data. Such heterogeneous transaction data may exist or be compiled in different formats. In various embodiments, the data transformer 256 can homogenize such data into homogeneous training data.

The data classifier 258 classifies, using a machine learning algorithm, the homogeneous training data based on various parameters such as, for example, data fields and values. In various cases, the data classifier 258 can classify using, for example, artificial neural networks, decision trees, ensemble learning, and/or the like. The classified data can be stored, for example, in the data store 265.

The hybrid dataset generator 266 includes an automatic collector 268 and a manual collector 272. In various embodiments, the automatic collector 268 and the manual collector 272 can operate individually, or in combination, to generate a business process dataset related to a user-executed process. The business process dataset can include information describing a user-executed process such as, for example, identification of a plurality of steps that are performed as part of the user-executed process, data describing how the user-executed process is executed (e.g., technical documentation), data sources that are accessed in each step of the user-executed process, applications and UIs of the application that are used in each step of the user-executed process, other data related to a user-executed process such as the data described herein, combinations of the foregoing and/or the like. In some cases, the level of detail regarding the plurality of steps can be similar to that of the instruction set 126 of FIG. 1. For example, the automatic collector 268 can retrieve, or receive, ingested data from the knowledge management system 270 that describes the user-executed process.

In various embodiments, the manual collector 272 can generate the business process dataset, at least in part, via interaction with an administrator, super user, or other user. For example, in some embodiments, the manual collector 272 solicits and receives at least a portion of the business process dataset using a web form or similar method. In some embodiments, the manual collector 272 can be used to fill information gaps, for example, due to some information not being available for automatic generation by the automatic collector 268. For instance, in some embodiments, the manual collector 272 can solicit and receive information regarding locations of data sources that are used in the user-executed process.

In general, the business process dataset generated by the hybrid dataset generator 266 can include all or any subset of the example data mentioned above. The business process dataset can also include additional data that will be apparent to one skilled in the art after a detailed review of the present disclosure. It should be appreciated that, in various embodiments, the business process dataset can be generated entirely automatically by the automatic collector 268, entirely non-automatically by the manual collector 272, or part automatically and part non-automatically via a configurable combination of the automatic collector 268 and the manual collector 272.

In various aspects, the training module 260 can coordinate a process for on-demand training and deployment. In certain aspects, the training module 260 can allocate and train a bot for one or more skillsets responsive to a request from user (e.g., a user of one or more of the user systems 160 of FIG. 1). In various aspects, the bot that is allocated and trained can be a bot that is newly created and added to the managed bots 120 of FIG. 1, for example, for a particular tenant. In other aspects, the bot that is allocated and trained can be an existing bot among the managed bots 120 of a particular tenant.

In certain aspects, the training module 260 can automatically allocate and train a bot for the one or more skillsets using stored content related to human training for the at least one skillset, for example, from the knowledge management system 270. In addition, or alternatively, the stored content on which the bot is trained can include, for example, a business process dataset, homogeneous training data, heterogeneous training data, combinations of the foregoing and/or the like. In some aspects, the training can include generating, or causing to be generated, an instruction set for the bot based on the stored content, as discussed above. In addition, or alternatively, the training can include, for example, creating and/or training one or more machine learning models for utilization by the bot when the bot robotically executes such an instruction set.

In some aspects, the training module 260 can initially create a plurality of machine learning models based on an initial set of classified data, where each machine-learning model can correspond to a skillset, a user-executed process, and/or a step or task of a user-executed process. Thereafter, the training module 260 can facilitate incremental learning based on new classified data, for example, from the data classifier 258. For example, the training module 260 can select process steps for the new classified data and provide the new classified data as input data for the corresponding machine-learning model(s). Example operation of the training module 260 will be discussed in greater detail relative to FIG. 3.

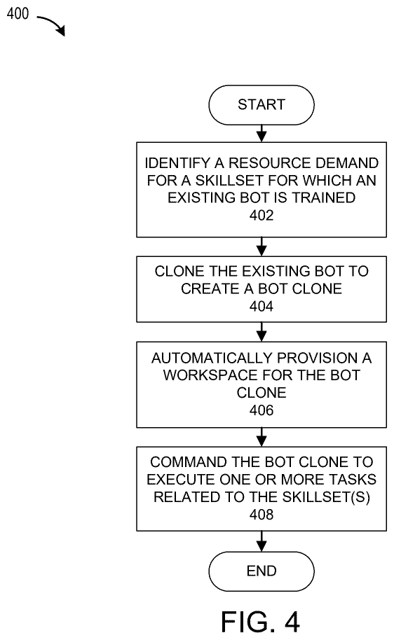

In certain aspects, the bot cloning module 262 can serve to clone, for example, any of the managed bots 120 that are already trained to execute one or more skillsets corresponding to one or more user-executed processes. In certain aspects, the bot cloning module 262 can execute its cloning functionality in response to a resource demand for a given skillset. Example operation of the bot cloning module 262 will be described in greater detail relative to FIG. 4.

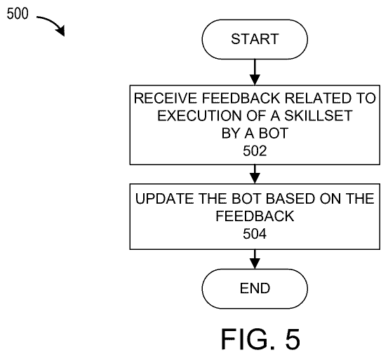

In certain aspects, the feedback module 264 is operable to update or retrain, for example, any of the managed bots 120 that are trained to execute a given skillset. In certain aspects, the feedback module 264 can receive feedback, for example, related to execution of a skill skillset by a given bot of the managed bots 120. The feedback can be received, for example, from a user of the feedback environments 280. Example operation of the feedback module 264 will be described in greater detail relative to FIG. 5.

FIG. 3 illustrates an example of a process 300 for operating the on-demand training and deployment system 157 of FIGS. 1 and 2. In certain embodiments, the process 300 can be implemented by any system that can process data. Although any number of systems, in whole or in part, can implement the process 300, to simplify discussion, the process 300 will be described in relation to particular components shown and described relative to FIGS. 1 and 2.

At block 302, the on-demand training and deployment system 157 receives a command to initiate on-demand robotic execution in relation to at least one skillset (e.g., a skillset or combination of skillsets). In certain aspects, the command can be received, for example, by the training module 260 from an administrator or other user of one or more of the user systems 160. In some aspects, the command can be received by the training module 260 from a bot, system, or component based on an automated determination that robotic execution would be beneficial. For example, the command can be received from the workforce manager 151 in response to an automated determination of a need for a skillset (e.g., based on workload of one or more of the managed human workers 123 reaching a predetermined threshold).

In some aspects, the received command can identify the at least one skillset by indicating stored content related to human training for that skillset or combination of skillsets. In some of these aspects, the stored content can be identified by user input associated with the at least one skillset. The stored content can represent, for example, a selection of content from the knowledge management system 270. The selection can relate to a file system structure such as a folder or directory, be identified via one or more uniform resource locators (URLs), and/or the like. In addition, or alternatively, the stored content can include content related to human training for that skillset or combination of skillsets.

In some aspects, the received command can identify the at least one skillset by indicating a role corresponding, for example, to one or more of the managed human workers 123. According to this example, in some aspects, the role can then can be automatically mapped to stored content related to human training for that skillset or combination of skillsets. In addition, or alternatively, the received command can identify the at least one skillset by indicating one or more skills or roles, for example, in a taxonomy of skills or roles. According to this example, in some aspects, the taxonomy can be pre-associated with stored content in the knowledge management system 270, such that the indicated skills and/or roles can be automatically mapped to such stored content.

At block 304, the on-demand training and deployment system 157 automatically allocates a bot for the at least one skillset responsive to the command. In some aspects, the allocating can include, for example, the training module 260 communicating with other components, such as the bot creation module 143 and the bot deployment module 144, to create and deploy the bot (e.g., over the course of the process 300), such that the bot, once created, trained and deployed according to the process 300, is added to the managed bots 120. In other aspects, the allocating can include utilizing an existing bot among the managed bots 120.

At block 306, the on-demand training and deployment system 157 automatically provisions a workspace for the bot allocated at the block 304, where the workspace can be based on the at least one skillset. The workspace can correspond, for example, to one or more of the bot environments 276 of FIG. 2, inclusive of computer resources and software applications for executing configurable tasks. The block 306 can include creating the workspace, such that the workspace is added to the bot environments 276 of FIG. 2. In other aspects, the provisioning can utilize an existing bot environment among the bot environments 276. In some aspects, the provisioning can be based on, or duplicated from, one of the human-worker environments 278 utilized by a human worker having a role corresponding to the at least one skillset.

At block 308, the on-demand training and deployment system 157 automatically trains the bot for the at least one skillset using, for example, stored content related to human training for the at least one skillset. The automatic training at the block 308 can include, for example, the training module 260 generating, or causing generation of, an instruction set similar to the instruction set 126 discussed relative to FIG. 1, based on the stored content. In addition, or alternatively, the block 308 can include, for example, the training module 260 training a machine learning model for utilization by the bot when the bot robotically executes the at least one skillset, or the instruction set to which the skillset corresponds.

As discussed previously, in some aspects, the stored content can be automatically mapped to the skillset based on, or in association with, the command received at the block 302. For example, the skillset can be indicated by user input associated with the command. According to this example, in some aspects, the training module 260 can automatically identify at least a portion of the stored content by searching, for example, the knowledge management system 270 and/or an enterprise resource planning (ERP) system (e.g., using the skillset as a search query). In addition, or alternatively, in some aspects, the skillset can be provided as input to a corresponding machine learning model to search for, and automatically identify, the stored content (e.g., by searching the knowledge management system 270 and/or an enterprise resource planning (ERP) system).

As discussed previously, the stored content on which the bot is trained can include, for example, data related to how one or more user-executed processes are executed. In various examples, the stored content on which the bot is trained can include, for example, process documents, knowledge base files, emails, instant messages, voicemails, system alerts, on-screen tips, bite-sized training materials and/or help files in video, audio, image and/or document formats. In various aspects, the stored content can describe, for example, software skills and/or business process skills. In addition, or alternatively, the stored content can describe, for example, an organizational structure, history, mission, and/or vision. In addition, or alternatively, the stored content can describe or include, for example, ethical policies, compliance and regulations training, mandatory trainings, and/or the like. In addition, or alternatively, the stored content on which the bot is trained can include, for example, a business process dataset, homogeneous training data, heterogeneous training data, combinations of the foregoing and/or the like, as discussed previously.

At block 310, the on-demand training and deployment system 157 commands the bot to execute one or more tasks related to the at least one skillset. For example, in some aspects, the training module 260 can interact, for example, with the workforce manager 151, to assign the one or more tasks to the bot using a project management system. In some aspects, the assignment can represent a reassignment from one or more of the managed human workers 123 to the bot. The commanding can include, for example, generating and sending a communication to the bot over a computer network. The communication can include using communication methods similar to those used to communicate with human workers, such as email, synchronous communication (e.g., instant messaging), audio and/or video communication, and/or the like. After block 310, the process 300 ends.

FIG. 4 illustrates an example of a process 400 for cloning a trained bot in response to a resource demand. In certain embodiments, the process 400 can be implemented by any system that can process data. Although any number of systems, in whole or in part, can implement the process 400, to simplify discussion, the process 400 will be described in relation to particular components shown and described relative to FIGS. 1 and 2.

At block 402, the on-demand training and deployment system 157 identifies a resource demand for at least one skillset for which an existing bot of the managed bots 120 is trained. In an example, the block 402 can include the bot cloning module 262 receiving a command or indication from a user via, for example, the user systems 160. In another example, the block 402 can include the bot cloning module 262 receiving a command or indication from a system or component or thereof, such as the workforce manager 151 of FIG. 1. In certain aspects, the existing bot may have been trained according to the process 300 of FIG. 3.

At block 404, the on-demand training and deployment system 157 clones the existing bot in response to the identified resource demand to create a new bot that is a clone of the existing bot (sometimes referred to herein as a “bot clone”). For example, the block 404 can include the bot cloning module 262 communicating with other components, such as the bot creation module 143 and the bot deployment module 144, to create and deploy the bot clone (e.g., over the course of the process 400) using, for example, the same instruction set and machine learning models as the existing bot. In this way, the bot clone, once created and deployed, can be added to the managed bots 120.

At block 406, the on-demand training and deployment system 157 automatically provisions a workspace for the bot clone, where the workspace can be based on the at least one skillset, as discussed relative to the block 306 of FIG. 3. In certain aspects, the workspace for the bot clone can have the same configuration as the workspace for the existing bot. For example, the provisioning can be based on, or duplicated from, the workspace for the existing bot. The workspace for the bot clone can correspond, for example, to one or more of the bot environments 276 of FIG. 2, inclusive of computer resources and software applications for executing configurable tasks. The block 306 can include creating the workspace, such that the workspace is added to the bot environments 276 of FIG. 2.

At block 408, the on-demand training and deployment system 157 commands the bot clone to execute one or more tasks related to the at least one skillset. For example, in some aspects, the bot cloning module 262 and/or the training module 260 can interact, for example, with the workforce manager 151, to assign the one or more tasks to the bot clone using a project management system. In some aspects, the assignment can represent a reassignment from one or more of the managed human workers 123, and/or from one or more of the managed bots 120, to the bot clone. The commanding can include, for example, generating and sending a communication to the bot over a computer network. The communication can include using communication methods similar to those used to communicate with human workers, such as email, synchronous communication (e.g., instant messaging), audio and/or video communication, and/or the like. After block 408, the process 400 ends.

FIG. 5 illustrates an example of a process 500 for updating bots based on feedback. In certain embodiments, the process 500 can be implemented by any system that can process data. Although any number of systems, in whole or in part, can implement the process 500, to simplify discussion, the process 500 will be described in relation to particular components shown and described relative to FIGS. 1 and 2.

At block 502, the on-demand training and deployment system 157 receives feedback related to execution of a skillset by a bot of the managed bots 120. The feedback can be received, for example, by the feedback module 264, from a user of one or more of the feedback environments 280 discussed relative to FIG. 2. The feedback may be received, for example, following the user's review of one or more tasks completed by the bot. In some aspects, the feedback can indicate that a result or output of the bot is incorrect, indicate that the task was incorrectly executed, and/or provide other feedback. In some aspects, the feedback can further indicate a correct result or output and/or a correct execution of the one or more tasks.

At block 504, the on-demand training and deployment system 157 updates the bot based on the feedback. For example, in some aspects, the feedback module 264 and/or the training module 260 can retrain the bot based on the feedback in similar fashion to the block 308 of FIG. 3. The retraining can include, for example, updating the instruction set of the bot, retraining one or more machine learning models utilized by the bot, and/or the like. In certain aspects, the update at the block 504 can thereby improve the efficiency of the bot. After block 504, the process 500 ends.

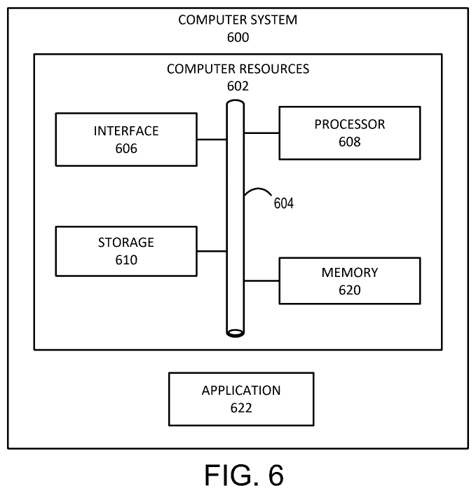

FIG. 6 illustrates an example of a computer system 600 that, in some cases, can be representative, for example, of the central management system 140, the RPA platforms 124, the tenant systems 110, the user systems 160 and/or a module or sub-component of the foregoing. The computer system 600 includes an application 622 operable to execute on computer resources 602. The application 622 can be, for example, any of the systems or modules illustrated in FIG. 1 or FIG. 2. In particular embodiments, the computer system 600 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the computer system 600 may comprise any suitable physical form, configuration, number, type and/or layout. As an example, and not by way of limitation, the computer system 600 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 600 may include one or more computer systems; be unitary or distributed; span multiple locations; span multiple machines; or reside in a cloud, which may include one or more cloud components in one or more networks.

In the depicted embodiment, the computer system 600 includes a processor 608, memory 620, storage 610, interface 606, and bus 604. Although a particular computer system is depicted having a particular number of particular components in a particular arrangement, this disclosure contemplates any suitable computer system having any suitable number of any suitable components in any suitable arrangement.

Processor 608 may be a microprocessor, controller, or any other suitable computing device, resource, or combination of hardware, software and/or encoded logic operable to execute, either alone or in conjunction with other components, (e.g., memory 620), the application 622. Such functionality may include providing various features discussed herein. In particular embodiments, processor 608 may include hardware for executing instructions, such as those making up the application 622. As an example, and not by way of limitation, to execute instructions, processor 608 may retrieve (or fetch) instructions from an internal register, an internal cache, memory 620, or storage 610; decode and execute them; and then write one or more results to an internal register, an internal cache, memory 620, or storage 610.

In particular embodiments, processor 608 may include one or more internal caches for data, instructions, or addresses. This disclosure contemplates processor 608 including any suitable number of any suitable internal caches, where appropriate. As an example, and not by way of limitation, processor 608 may include one or more instruction caches, one or more data caches, and one or more translation lookaside buffers (TLBs). Instructions in the instruction caches may be copies of instructions in memory 620 or storage 610 and the instruction caches may speed up retrieval of those instructions by processor 608. Data in the data caches may be copies of data in memory 620 or storage 610 for instructions executing at processor 608 to operate on; the results of previous instructions executed at processor 608 for access by subsequent instructions executing at processor 608, or for writing to memory 620, or storage 610; or other suitable data. The data caches may speed up read or write operations by processor 608. The TLBs may speed up virtual-address translations for processor 608. In particular embodiments, processor 608 may include one or more internal registers for data, instructions, or addresses. Depending on the embodiment, processor 608 may include any suitable number of any suitable internal registers, where appropriate. Where appropriate, processor 608 may include one or more arithmetic logic units (ALUs); be a multi-core processor; include one or more processors 608; or any other suitable processor.

Memory 620 may be any form of volatile or non-volatile memory including, without limitation, magnetic media, optical media, random access memory (RAM), read-only memory (ROM), flash memory, removable media, or any other suitable local or remote memory component or components. In particular embodiments, memory 620 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 620 may include one or more memories 620, where appropriate. Memory 620 may store any suitable data or information utilized by the computer system 600, including software embedded in a computer readable medium, and/or encoded logic incorporated in hardware or otherwise stored (e.g., firmware). In particular embodiments, memory 620 may include main memory for storing instructions for processor 608 to execute or data for processor 608 to operate on. In particular embodiments, one or more memory management units (MMUs) may reside between processor 608 and memory 620 and facilitate accesses to memory 620 requested by processor 608.

As an example, and not by way of limitation, the computer system 600 may load instructions from storage 610 or another source (such as, for example, another computer system) to memory 620. Processor 608 may then load the instructions from memory 620 to an internal register or internal cache. To execute the instructions, processor 608 may retrieve the instructions from the internal register or internal cache and decode them. During or after execution of the instructions, processor 608 may write one or more results (which may be intermediate or final results) to the internal register or internal cache. Processor 608 may then write one or more of those results to memory 620. In particular embodiments, processor 608 may execute only instructions in one or more internal registers or internal caches or in memory 620 (as opposed to storage 610 or elsewhere) and may operate only on data in one or more internal registers or internal caches or in memory 620 (as opposed to storage 610 or elsewhere).

In particular embodiments, storage 610 may include mass storage for data or instructions. As an example, and not by way of limitation, storage 610 may include a hard disk drive (HDD), a floppy disk drive, flash memory, an optical disc, a magneto-optical disc, magnetic tape, or a Universal Serial Bus (USB) drive or a combination of two or more of these. Storage 610 may include removable or non-removable (or fixed) media, where appropriate. Storage 610 may be internal or external to the computer system 600, where appropriate. In particular embodiments, storage 610 may be non-volatile, solid-state memory. In particular embodiments, storage 610 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 610 may take any suitable physical form and may comprise any suitable number or type of storage. Storage 610 may include one or more storage control units facilitating communication between processor 608 and storage 610, where appropriate.

In particular embodiments, interface 606 may include hardware, encoded software, or both providing one or more interfaces for communication (such as, for example, packet-based communication) among any networks, any network devices, and/or any other computer systems. As an example, and not by way of limitation, communication interface 606 may include a network interface controller (NIC) or network adapter for communicating with an Ethernet or other wire-based network and/or a wireless NIC (WNIC) or wireless adapter for communicating with a wireless network.

Depending on the embodiment, interface 606 may be any type of interface suitable for any type of network for which computer system 600 is used. As an example, and not by way of limitation, computer system 600 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 600 may include any suitable interface 606 for any one or more of these networks, where appropriate.

In some embodiments, interface 606 may include one or more interfaces for one or more I/O devices. One or more of these I/O devices may enable communication between a person and the computer system 600. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 606 for them. Where appropriate, interface 606 may include one or more drivers enabling processor 608 to drive one or more of these I/O devices. Interface 606 may include one or more interfaces 606, where appropriate.

Bus 604 may include any combination of hardware, software embedded in a computer readable medium, and/or encoded logic incorporated in hardware or otherwise stored (e.g., firmware) to couple components of the computer system 600 to each other. As an example, and not by way of limitation, bus 604 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 604 may include any number, type, and/or configuration of buses 604, where appropriate. In particular embodiments, one or more buses 604 (which may each include an address bus and a data bus) may couple processor 608 to memory 620. Bus 604 may include one or more memory buses.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 608 (such as, for example, one or more internal registers or caches), one or more portions of memory 620, one or more portions of storage 610, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments, are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method for on-demand training and deployment of bots, the method comprising, by a computer system:
receiving a command to initiate on-demand robotic execution in relation to at least one skillset;
allocating a bot for the at least one skillset responsive to the command;
automatically provisioning a workspace for the bot based on the at least one skillset;
automatically training the bot for the at least one skillset using stored content related to human training for the at least one skill set; and
commanding the automatically trained bot to execute one or more tasks related to the skillset.

2. The method of claim 1, wherein the allocating comprising creating the bot using a robotic process automation (RPA) platform.

3. The method of claim 1, wherein the received command identifies the skillset by indicating the stored content related to human training for the at least one skillset.

4. The method of claim 1, further comprising automatically identifying, by the computer system, the stored content based on user input associated with the at least one skillset.

5. The method of claim 1, wherein the training comprises generating an instruction set for the bot based on the stored content.

6. The method of claim 1, wherein the training comprises training a machine learning model for utilization by the bot when the bot robotically executes the at least one skillset.

7. The method of claim 1, wherein the at least one skillset comprises a plurality of skillsets, the training comprising training the bot for each of the plurality of skillsets using the stored content.

8. The method of claim 1, wherein the commanding comprises assigning the one or more tasks to the bot using a project management system.

9. The method of claim 1, wherein the commanding comprises generating and sending a communication to the bot over a computer network.

10. The method of claim 9, wherein the communication comprises at least one of an email or a synchronous communication.

11. The method of claim 1, further comprising:
identifying a resource demand for the at least one skill set;
cloning the bot to create a bot clone; and
commanding the bot clone to execute one or more tasks related to the skillset.

12. The method of claim 1, further comprising:
receiving feedback following completion of the one or more tasks; and
updating the bot based on the feedback.

13. A system comprising a processor and memory, wherein the processor and memory in combination are operable to implement a method for on-demand training and deployment of bots, the method comprising:
receiving a command to initiate on-demand robotic execution in relation to at least one skillset;
allocating a bot for the at least one skillset responsive to the command;
automatically provisioning a workspace for the bot based on the at least one skillset;
automatically training the bot for the at least one skillset using stored content related to human training for the at least one skill set; and
commanding the automatically trained bot to execute one or more tasks related to the skillset.

14. The system of claim 13, wherein the training comprises training a machine learning model for utilization by the bot when the bot robotically executes the at least one skillset.

15. The system of claim 13, wherein the commanding comprises assigning the one or more tasks to the bot using a project management system.

16. The system of claim 13, wherein the commanding comprises generating and sending a communication to the bot over a computer network.

17. The system of claim 13, further comprising:
identifying a resource demand for the at least one skill set;
cloning the bot to create a bot clone; and
commanding the bot clone to execute one or more tasks related to the skillset.

18. The method of claim 13, further comprising:
receiving feedback following completion of the one or more tasks; and
updating the bot based on the feedback.

19. The system of claim 13, wherein the allocating comprising creating the bot using a robotic process automation (RPA) platform.

20. A computer-program product comprising a non-transitory computer-usable medium having computer-readable program code embodied therein, the computer-readable program code adapted to be executed to implement a method for on-demand training and deployment of bots, the method comprising:
receiving a command to initiate on-demand robotic execution in relation to at least one skillset;
allocating a bot for the at least one skillset responsive to the command;
automatically provisioning a workspace for the bot based on the at least one skillset;
automatically training the bot for the at least one skillset using stored content related to human training for the at least one skill set; and
commanding the automatically trained bot to execute one or more tasks related to the skillset.
